(19) United States
(12) Patent Application Publication
(10) Pub. No.: US 2002/0087293 A1
(43) Pub. Date: Jul. 4, 2002

(54) Exceedance protection process

(76) Inventor: Marshall Wayne Thomas, Cincinnati, OH (US)

Correspondence Address: BARBARA JOAN HAUSHALTER, LAW OFFICE, 228 BENT PINES CT., BELLEFONTAINE, OH, 43311, US

(21) Appl. No.: 09/754,756

(22) Filed: Jan. 4, 2001

(51) Int. Cl. G06F 9/45

(52) U.S. Cl. 703/2

(57) ABSTRACT

A system or method allows for a design to conform to existing design requirements. Specified, quantifiable limits are inserted into an input file of relevant design analyses tools. An output of the analyses is then compared to the limits, such as by creating a sub-routine within the relevant design analyses tools to automatically compare an output of the analyses to the specified, quantifiable limits. An alert message is issued or output indicative of whether the comparison identifies an exceedance of the specified, quantifiable limits.

### BACKGROUND OF THE INVENTION

The present invention relates to design processes in all types of business environments.

Most current design processes rely on the designer and the design reviewers to be knowledgeable of current design limit criteria, usually identified in documents created during previous design processes. The current design limit criteria is in the form of general guidance and specific quantified limits. Knowledge of these limits is required in order to judge the compliance of a particular design feature with the rules identifying associated design practices. Misinterpretation or unawareness of these quantifiable limits may inadvertently result in the perpetuation of a design effort that is non-compliant with relevant design requirements and may ultimately result in field related problems.

Detecting an inadvertent non-compliance with a design practice limit is currently dependent on the quality of the design review process. Non-detection may ultimately require subsequent additional redesign efforts. Such redesign effort, if required, consumes additional manpower and time to bring the planned design into compliance with specified limits.

One current approach to reduce this problem provides designers easy access to the design practices and requirements. Technical reviews can also be conducted to ascertain compliance to the relevant design practice limits. The review process can be composed of working level, work-in-progress reviews and formal reviews by the chief engineer's office, or chief designer's office. The review process, whether it is an in-progress review or a formal review, compares proposed designs to the design criteria. Deviations from the design criteria are noted and appropriate action is implemented.

It would be desirable to provide a more real-time method and system for comparing current design features to required and quantifiable limits for design.

### BRIEF SUMMARY OF THE INVENTION

A method and system is proposed for providing design practice limits and criteria in a real-time manner within analysis tools. This provides the designer with the most current values of the limits without requiring designer intervention for the input.

Accordingly, the present invention provides a process for improving product quality and productivity by supplying key quantifiable design practice limits as an electronically readable file automatically accessed by analysis tools. The analysis tools will then be capable of comparing calculated results with the design practice limits to determine if exceedances have occurred.

### BRIEF DESCRIPTION OF THE DRAWING

FIG. 1 is a schematic block diagram illustrating the exceedance protection process for design practice limits.

### DETAILED DESCRIPTION OF THE INVENTION

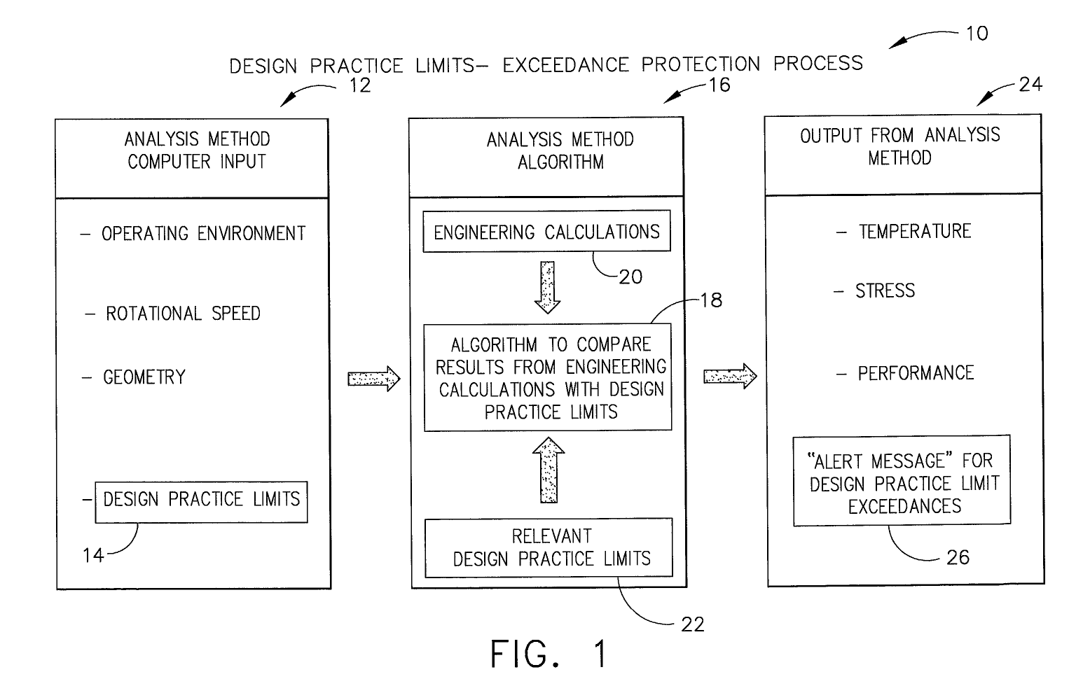

Referring to FIG. 1, there is a schematic block diagram 10 illustrating the exceedance protection process of the invention. It is typical for corporations to have established guidelines for the design of products and parts, particularly when safety is an issue with the products or parts, as in the aerospace and automotive industries. These guidelines, or design practices, are contained together for reference during the design process.

By way of example, design practices establish guidelines for the aerodynamic design of gas turbine engine components, such as turbine airfoils. The primary function of the turbine airfoils is to effect the angular momentum changes consistent with the operational requirements of the engine system. Implicit within this function is the necessity to meet aerodynamic performance levels. The design practice, therefore, for turbine airfoils, covers material that encompasses preliminary as well as detailed design criteria and procedures. The design criteria are typically created during previous design processes, to incorporate “best practices” as well as “lessons learned” from the previous design projects, and can change or be updated frequently. This material can be quite voluminous in detail and length. The designer and design reviewers must be knowledgeable of these design limit criteria.

Currently, compliance with the design criteria requires that the designer and design reviewers have access to volumes of documents relevant to all of the key features of the design. Engineering calculations of proposed designs are then manually compared with the design practice limits to insure compliance with those limits. This can be a labor-intensive process, requiring repetitive comparison calculations before compliance of a new design is achieved.

Referring to FIG. 1, block diagram 10 illustrates a more real-time process for achieving the compliance of a new design with the existing design practice limits. The designer has certain design analyses tools available, often for use in conjunction with existing computer software. The present invention proposes automating the comparison process to provide the design practice limits as well as comparison of proposed designs to those limits during the design phase.

Continuing with FIG. 1, initially, at input block 12, inputs are provided relating to the analysis method. These inputs include the quantifiable limits specified in the design practices, indicated by sub-block 14. The design practice limits 14 are insertable into the input file of the relevant design analyses tools. This incorporates the design practice limits as a computer input, to interact with additional inputs such as the operating environment parameters, the rotational speed, and the design and part geometries, all represented by input block 12. The design practice limits can include numerous parameters such as, but not limited to, the level of aerodynamic performance, power output, temperature and stress capacity, mechanical integrity, acoustics, and axial, circumferential and radial directional loads.

An analysis is then applied to the inputs, as indicated by analysis block 16. The analysis may be achieved by any suitable means, such as a sub-routine created within the design analyses tools. The analysis, or sub-routine, 16 automatically compares at 18 the output of block 20 with the relevant portions 22 of the design practice limits 14 from input block 12. Block 20 is an analyses using engineering calculations, relating, for example, to pressure level, temperature level, stress level, key dimension, and other parameters. Therefore, relevant portions 22 of the design practice limits are compared with results from engineering calculations 20 relevant to the design. The engineering calculations can be heat transfer, component efficiency, stress, parts life, or any other basic engineering parameter or result.

The output of this comparison at 18 is provided at block 24, where an “alert” type message 26 can be issued in the output of the analyses tools to notify the designer if the analysis identifies an exceedance of the prescribed design practice limits. In addition to the alert messages for design practice limit exceedances, the analysis also outputs information such as temperature, stress and performance results of the proposed design. A typical example of an algorithm to detect exceedances is:

If computer model calculated stress level is >Design Practice Limit for this part and function, then Exceedance is identified and alert issued.

In a further embodiment, the process can utilize an electronic version of the design practices in such a manner that its key quantifiable limits are electronically readable by the analysis tools. The electronic version can be any suitable means, such as a web-based or similar tool. This can provide the most current values of the limits without requiring designer intervention for the input.

The exceedance protection process improves product quality by reducing the design vulnerability associated with mis-interpretation or lack of awareness of key limits in design practices. The process also improves productivity by reducing the expenditures of time and manpower to redo engineering analysis and designs formerly associated with initial designs that violate key limits in design practices.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for conforming a design with existing design requirements, the method comprising the steps of:
inserting limits into an input file of relevant design parameters;
inputting the input file into an analysis algorithm;
applying the analysis algorithm to perform calculations to generate an analyses output;
comparing the analyses output to the limits to generate a design output; and
issuing an alert indicative of whether the comparison identifies an exceedance of the limits.

2. A method as claimed in claim 1 wherein the limits comprise specified quantifiable limits.

3. A method as claimed in claim 1 wherein the step of inserting limits comprises the step of using a web-based tool to electronically read the limits.

4. A method as claimed in claim 1 wherein the step of comparing comprises the step of creating a sub-routine to automatically compare the analyses output with the limits.

5. A method as claimed in claim 4 wherein the analyses output comprises engineering calculations relevant to the design.

6. A method as claimed in claim 5 wherein the step of applying the analysis algorithm comprises the step of applying an exceedance detection algorithm.

7. A method as claimed in claim 6 wherein the exceedance detection algorithm indicates if an exceedance of a computer model engineering calculation is greater than the limits.

8. A method as claimed in claim 1 wherein the step of issuing an alert comprises the step of issuing an alert message to a user.

9. A method as claimed in claim 1 further comprising the step of outputting engineering specifications and performance results of the design.

10. A system for conforming a design with existing design requirements, the system comprising:
an input file containing at least predetermined design practice limits;
an analysis algorithm for comparing the input file with design criteria to generate an output;
an exceedance algorithm for comparing the output to the predetermined design practice limits; and
an alert indicator for indicating whether the exceedance algorithm comparison identifies an exceedance of the predetermined design practice limits.

11. A system as claimed in claim 10 wherein the predetermined design practice limits comprise specified quantifiable limits.

12. A system as claimed in claim 10 wherein the predetermined design practice limits are electronically readable.

13. A system as claimed in claim 12 further comprising a web-based tool to electronically read the predetermined design practice limits.

14. A system as claimed in claim 10 wherein the exceedance algorithm comprises a sub-routine to automatically compare the output with the predetermined design practice limits.

15. A system as claimed in claim 14 wherein the output comprises engineering calculations relevant to the design.

16. A system as claimed in claim 10 wherein the exceedance detection algorithm indicates when an exceedance of a computer model engineering calculation is greater than the predetermined design practice limits.

17. A system as claimed in claim 10 wherein the alert indicator comprises an alert message issued to a user.

18. A system as claimed in claim 10 further comprising engineering specifications and performance results of the design.
